(19) United States
(12) Patent Application Publication
(10) Pub. No.: US 2026/0258695 A1
(43) Pub. Date: Sep. 3, 2026

(54) GLAZING

(71) Applicant: Bauglasindustrie GmbH, Schmelz/Saar (DE)

(72) Inventors: Herbert SCHÖBEN, Nohfelden (DE); Wolfgang DUTT, Wallerfangen (DE); Salvatore TABONE, Saarlouis (DE)

(73) Assignee: Bauglasindustrie GmbH, Schmelz/Saar (DE)

(21) Appl. No.: 18/998,554

(22) PCT Filed: Aug. 1, 2023
(86) PCT No.: PCT/EP2023/071313

§ 371 Date: Jan. 27, 2025

(30) Foreign Application Priority Data
Aug. 1, 2022 (GB) 2211191.8

(51) Int. Cl. E06B 3/66; E06B 3/67

(52) U.S. Cl. CPC E06B 3/6608; E06B 3/6707; E06B 3/6715

(57) ABSTRACT

Glazings comprising first and second channel-section glazing elements are described. The first and second channel-section glazing elements are arranged to define a cavity in which an inner glazing element is located. The inner glazing element includes a central portion made of a first material, a first edge portion made of a second material and running along a first side of the central portion and a second edge portion made of a third material running along a second side of the central portion. The first material is different from the second material and the first edge portion is bonded to the central portion of the inner glazing element and is preferably integrally formed therewith. In preferred embodiments the second edge portion is also bonded to the central portion and preferably integrally formed therewith. Methods of making the inner glazing element are also described.

The present invention relates to a glazing having first and second channel-section glazing elements with an inner glazing element therebetween.

Glazing units comprising three spaced apart panes of glazing material are known in the art, such glazing units often being referred to as triple glazed windows. In such triple glazed windows each of the glazing elements, or panes, are usually planar sheets of glass.

Glazing elements are known having a profiled or channel-section configuration. A profiled or channel-section glazing element is made from a sheet or ribbon of glass and has at least one lateral edge bent upwards during manufacture. Usually both lateral edges are bent upwards during manufacture. Examples of making a channel-section glazing element are described in DE1496047A1. The upward facing portions of the channel-section glazing element are known in the art as “flanges” and the lower portion connected to the or each flange is known as a “web”. Since channel-section glazing elements are made from a continuous glass sheet or ribbon and cut to the desired length, the flanges are a continuation of the web and are at an angle thereto. Usually, the flanges are at an angle of substantially 90° to the web. A channel-section glazing element having two lateral flanges is often referred to as a U-profile glazing element because the channel-section glazing element has a U-shaped cross section.

EP 0 742 324 A1 describes a facade consisting of two rows of U-shaped glass sections, one row forming the inner skin with its bases and the other similarly forming the outer skin, such that the legs of the U's fit one inside the other. Cavities are filled with thermal insulation and a heat reflecting layer is provided on one of the outwards facing surfaces of the skins and/or the thermal insulation. The U-sections may be positioned so that they abut each other, and the legs of the U-sections are joined with PVC sealing strips and/or silicone sealing members. Such glazing units have limited visible transparency due to the nature of the thermal insulation. Furthermore, the facades having three U-sections described in EP 0742 324 A1 are relatively thick (the thickness of such a facade being the distance between the surface facing the exterior of a building in which the facade is installed and the surface facing the interior of the building in which the facade is installed).

WO2005/033432A1 describes a translucent glazing panel comprising: (a) a thermoplastic panel comprising (i) an outer wall having an inner surface defining an internal channel, the internal channel having an internal volume, and (ii) at least one inner wall protruding from the inner surface into the internal channel, and (b) hydrophobic aerogel particles, the hydrophobic aerogel particles being disposed within the channel. Such glazing panels are translucent and are not able to be used in applications requiring low haze.

Glazings including glass sheets between channel-section glazing elements are described in WO2015/007899A2. The glass sheets are held in position using clips.

Glazings including at least one row of profiled glass sheets arranged next to one another, each with at least one web and at least one flange, and at least one multiple web plate made of plastic, are described in EP3260621B1. The multiple web plates made of plastic are attached to a separate holding device and are not attached to the profiled glass sheets.

There is a need for an improved glazing unit that can be used in glazing applications where increased energy performance is required. The ability to retrofit such glazing units into existing glazing systems is desirable. The ability to be able to simplify the production and installation of such glazing units is also desirable.

Accordingly, the present invention provides from a first aspect a glazing comprising a first channel-section glazing element and a second channel-section glazing element, the first and second channel-section glazing elements each comprising a web and a first flange, the first flange running along a first lateral edge of the respective web, the first and second channel-section glazing elements being arranged such that an end of the first flange of the first channel-section glazing element faces the second channel-section glazing element and an end of the first flange of the second channel-section glazing element faces the first channel-section glazing element, wherein at least a portion of an inner glazing element is located between the web of the first channel-section glazing element and the web of the second channel-section glazing element, the inner glazing element comprising a central portion made of a first material, a first edge portion made of a second material and running along a first side of the central portion; and a second edge portion made of a third material and running along a second side of the central portion, the first side of the central portion being opposite the second side of the central portion; wherein the first material is different from the second material and further wherein the first edge portion of the inner glazing element is bonded to the central portion of the inner glazing element.

The first material has a first chemical composition, and the second material has a second chemical composition different from, or substantially different from, the first chemical composition.

The third material has a third chemical composition.

A glazing according to the present invention has an improved energy performance when compared to the same glazing without the inner glazing element. The inner glazing element helps improve the thermal insulation properties of the glazing. Furthermore, having different materials for the first edge portion and the central portion allows an inner glazing element to be provided that has more features in a component part of the glazing. The first material can be chosen to provide the central portion of the inner glazing element with desirable characteristics for this part of the inner glazing element, whereas the second material can be chosen to provide this part of the inner glazing element with other desirable characteristics that may not be the same as the desirable characteristics of the central portion. Also, by bonding the first edge portion of the inner glazing element to the central portion of the inner glazing element, this helps maintain the position of the first edge portion of the inner glazing element relative to the first flange of the first and/or second channel-section glazing element.

Preferably the second edge portion of the inner glazing element is bonded to the central portion of the inner glazing element.

Preferably the third material is different from the first material and the second edge portion of the inner glazing element is bonded to the central portion of the inner glazing element.

Preferably the third material is different from the first material and the second material, and the second edge portion of the inner glazing element is bonded to the central portion of the inner glazing element.

Preferably the second material is the same as the third material.

Preferably the central portion of the inner glazing element is suitably sized to fill the space between the web of the first channel-section glazing element and the web of the second channel-section glazing element.

Preferably the glazing is arranged such that there is a first space between the central portion of the inner glazing element and the web of the first channel-section glazing element and/or a second space between the central portion of the inner glazing element and the web of the second channel-section glazing element.

Preferably the central portion of the inner glazing element comprises at least a first wall spaced apart from a second wall, the first and second walls of the central portion of the inner glazing element having at least one space therebetween.

Preferably the central portion of the inner glazing element has a multi-wall construction comprising a first wall facing the web of the first channel-section glazing element and a second wall facing the web of the second channel-section glazing element, there being a plurality of air-spaces between the first and second walls of the central portion of the inner glazing element.

Such multi-wall construction plastic sheets are well known in the art, see for example DE2722817A1, EP0050462A1, DE202011003120U1, DE202011109408U1 and DE202011106659U1.

In some embodiments the web of the first channel-section glazing element has a second flange running along a second lateral edge thereof, the second lateral edge of the web of the first channel-section glazing element being opposite the first lateral edge of the web of the first channel-section glazing element, more preferably wherein the first channel-section glazing element has a U-shaped profile.

Preferably the first edge portion of the inner glazing element is adjacent the first flange of the first channel-section glazing element.

Preferably the second edge portion of the inner glazing element is adjacent the second flange of the first channel-section glazing element.

In some embodiments the web of the second channel-section glazing element has a second flange running along a second lateral edge thereof, the second lateral edge of the web of the second channel-section glazing element being opposite the first lateral edge of the web of the second channel-section glazing element, more preferably wherein the second channel-section glazing element has a U-shaped profile.

Preferably the first edge portion of the inner glazing element is adjacent the first flange of the second channel-section glazing element.

Preferably the second edge portion of the inner glazing element is adjacent the second flange of the second channel-section glazing element.

In some embodiments, the second material is the same as the third material and the first material is different to the second material and the third material.

In some embodiments the first edge portion of the inner glazing element is adjacent the first flange of the first channel-section glazing element.

In some embodiments the second edge portion of the inner glazing element is adjacent the first flange of the second channel-section glazing element.

In some embodiments the first edge portion of the inner glazing element comprises a first connection portion, wherein the first connection portion is made from a fourth material, further wherein the first connection portion is in mechanical communication with the first flange of the first channel-section glazing element.

The fourth material has a fourth chemical composition.

Preferably the fourth material is the same as the second material such that the fourth chemical composition is the same, or substantially the same, as the second chemical composition.

Preferably the first connection portion of the inner glazing element is attached to the first flange of first channel-section glazing element.

Preferably the first connection portion has a multi-wall construction comprising at least a first and a second wall with at least one air space therebetween.

Preferably the first connection portion comprises a first element biased against the first flange of the first channel-section element.

Preferably the first connection portion is adhesively attached to the first flange of the first channel-section glazing element.

In embodiments where the web of the first channel-section glazing element has a second flange running along a second lateral edge thereof, the second lateral edge of the web of the first channel-section glazing element being opposite the first lateral edge of the web of the first channel-section glazing element, preferably the first flange of the second channel-section glazing element is received in the space between the first and second flanges of the first channel-section glazing element.

In some embodiments, the first flange of the first and second channel-section glazing elements each has a respective first end opposite the respective web thereof, the glazing being arranged such that the first end of the first flange of the first channel-section glazing element faces the first end of the first flange of the second channel-section glazing element.

In some embodiments, the first flange of the first and second channel-section glazing elements each has a respective first end opposite the respective web thereof, the glazing being arranged such that the first end of the first flange of the first channel-section glazing element faces the first end of the first flange of the second channel-section glazing element, and the web of the first channel-section glazing element has a second flange running along a second lateral edge thereof, the second lateral edge of the web of the first channel-section glazing element being opposite the first lateral edge of the web of the first channel-section glazing element; and the web of the second channel-section glazing element has a second flange running along a second lateral edge thereof, the second lateral edge of the web of the second channel-section glazing element being opposite the first lateral edge of the web of the second channel-section glazing element; an end of the first flange of the first channel-section glazing element faces an end of the first flange of the second channel-section glazing element and an end of the second flange of the first channel-section glazing element faces an end of the second flange of the second channel-section glazing element.

In some embodiments the second edge portion of the inner glazing element comprises a second connection portion, wherein the second connection portion is made from a fifth material, further wherein the second connection portion is in mechanical communication with the first flange of the second channel-section glazing element, or when present, the second flange of the second channel-section glazing element.

The fifth material has a fifth chemical composition.

Preferably the fifth material is the same as the third material such that the fifth chemical composition is the same, or substantially the same, as the third chemical composition.

Preferably the second connection portion comprises a first element biased against the first flange of the second channel channel-section element, or when present, the second flange of the second channel-section glazing element.

Preferably the second connection portion is adhesively attached to the first flange of the second channel-section glazing element, or when present, the second flange of the second channel-section glazing element.

Preferably the second connection portion has a multi-wall construction comprising at least a first and a second wall with at least one air space therebetween.

In some embodiments the first edge portion of the inner glazing element comprises a first connection portion made from a fourth material and wherein the first connection portion is in mechanical communication with the first flanges of the first and second channel-section glazing elements, preferably wherein the first connection portion of the inner glazing element is attached to the first flanges of the first and second channel section glazing elements.

In some embodiments the web of the first channel-section glazing element has a second flange running along a second lateral edge thereof, the second lateral edge of the web of the first channel-section glazing element being opposite the first lateral edge of the web of the first channel-section glazing element, preferably wherein the first channel-section glazing element has a U-shaped profile; and the web of the second channel-section glazing element has a second flange running along a second lateral edge thereof, the second lateral edge of the web of the second channel-section glazing element being opposite the first lateral edge of the web of the second channel-section glazing element, preferably wherein the second channel-section glazing element has a U-shaped profile; and an end of the first flange of the first channel-section glazing element faces an end of the first flange of the second channel-section glazing element and an end of the second flange of the first channel-section glazing element faces an end of the second flange of the second channel-section glazing element.

Preferably the first edge portion of the inner glazing element comprises a first connection portion, and the first connection of the first edge portion of the inner glazing element is in mechanical communication with the first flanges of the first and second channel section glazing elements, preferably wherein the first connection portion of the first edge portion of the inner glazing element is attached to the first flanges of the first and second channel section glazing elements.

Preferably the second edge portion of the inner glazing element comprises a second connection portion and wherein the second connection portion of the inner glazing element is in mechanical communication with the second flanges of the first and second channel-section glazing elements, preferably wherein the second connection portion of the inner glazing element is attached to the second flanges of the first and second channel section glazing elements.

In some embodiments the glazing further comprises a third channel-section glazing element comprising a web and a first flange running along a first lateral edge thereof, the glazing being arranged such that the first flange of the first channel-section glazing element faces the web of the third channel-section glazing element; the first flange of the second and third channel-section glazing elements faces the web of the first channel-section glazing element, and wherein the first flange of the third channel-section glazing element is between the first flange of the first channel-section glazing element and the first flange of the second channel-section glazing element.

Preferably the web of the first channel-section glazing element has a second flange running along a second lateral edge thereof, the second lateral edge of the web of the first channel-section glazing element being opposite the first lateral edge of the web of the first channel-section glazing element, more preferably wherein the first channel-section glazing element has a U-shaped profile; and wherein the web of the second channel-section glazing element has a second flange running along a second lateral edge thereof, the second lateral edge of the web of the second channel-section glazing element being opposite the first lateral edge of the web of the second channel-section glazing element, more preferably wherein the second channel-section glazing element has a U-shaped profile; wherein the second flange of the first channel-section glazing element faces the web of the second channel-section glazing element.

Preferably the first edge portion of the inner glazing element comprises a first connection portion, wherein the first connection portion of the first edge portion of the inner glazing element is in mechanical communication with the first flange of the second channel-section glazing element and/or the first flange of the third channel-section glazing element, preferably wherein the first connection portion of the first edge portion of the inner glazing element is attached to the first flange of the second channel-section glazing element and/or the first flange of the third channel-section glazing element.

Preferably the glazing further comprises a fourth channel-section glazing element comprising a web and a first flange running along a first lateral edge thereof, the glazing being arranged such that the first flange of the fourth channel-section glazing element faces the web of the second channel-section glazing element; and wherein the first flange of the fourth channel-section glazing element is between the second flange of the first channel-section glazing element and the second flange of the second channel-section glazing element.

Preferably the second edge portion of the inner glazing element comprises a second connection portion and wherein the second connection portion of the second edge portion of the inner glazing element is in mechanical communication with the second flanges of the first and second channel-section glazing elements, preferably wherein the second connection portion of the second edge portion of the inner glazing element is attached to the second flanges of the first and second channel section glazing elements.

Preferably the second connection portion of the second edge portion of the inner glazing element is in mechanical communication with the first flange of the fourth channel-section glazing element, preferably wherein the second connection portion of the second edge portion of the inner glazing element is attached to the first flange of the fourth channel-section glazing element.

Other embodiments have other preferable features.

Preferably the first and/or second channel-section glazing elements comprise glass, more preferably a glass having a soda-lime-silica glass composition.

A typical soda-lime-silica glass composition is (by weight), SiO₂ 69-74%; Al₂O₃ 0-3%; Na₂O 10-16%; K₂O 0-5%; MgO 0-6%; CaO 5-14%; SO₃ 0-2%; Fe₂O₃ 0.005-2%. The glass may also contain other additives, for example, refining aids, which would normally be present in an amount of up to 2%.

When present, preferably the first connection portion has a thickness between 0.5 mm and 50 mm, more preferably between 0.5 mm and 40 mm, or 30 mm, or 20 mm, or 10 mm.

When present, preferably the second connection portion has a thickness between 0.5 mm and 50 mm, more preferably between 0.5 mm and 40 mm, or 30 mm, or 20 mm, or 10 mm.

In some embodiments the first edge portion of the inner glazing element is bonded to the central portion of the inner glazing element by an adhesive.

Any suitable adhesive may be used. The adhesive may be a permanent adhesive or a re-stickable adhesive.

Prior to bonding the first edge portion of the inner glazing element to the central portion of the inner glazing element, the adhesive is preferably in sheet form or liquid form.

An example of an adhesive in sheet form is a doubled sided adhesive tape.

It is most preferred that the adhesive be in liquid form prior to bonding.

Suitable adhesives include acrylic, anaerobic, cyanoacrylates, and epoxy adhesives.

The adhesive may be a hot melt adhesive. If the adhesive is a hot melt adhesive, the temperature used to provide the hot melt adhesive is preferably below a temperature that may cause the central portion and/or the first edge portion of the inner glazing element to degrade, deform or decompose.

When the second edge portion is bonded to the central portion of the inner glazing element, adhesive bonding as just described may be used to bond the second edge portion to the central portion of the inner glazing element.

In some embodiments the first edge portion of the inner glazing element is bonded to the central portion of the inner glazing element by a mechanical fastener.

Suitable mechanical fasteners include hook and loop fasteners such as Velcro type material.

When the second edge portion is bonded to the central portion of the inner glazing element, a mechanical fastener as just described may be used to bond the second edge portion to the central portion of the inner glazing element.

In some embodiments the first edge portion of the inner glazing element is bonded to the central portion of the inner glazing element by being fused therewith or thereto.

Preferably the first edge portion of the inner glazing element is thermally fused with or to the central portion of the inner glazing element.

In these embodiments, to bond the first edge portion of the inner glazing element to the central portion of the inner glazing element, the temperature of at least a portion of the first edge portion of the inner glazing element is increased to soften the first material, and the heat softened portion of the first edge portion is contacted with the first side of the central portion of the inner glazing element to bond therewith or thereto.

Alternatively, or in addition to, to bond the first edge portion of the inner glazing element to the central portion of the inner glazing element, the temperature of at least a portion of the first side of the central portion of the inner glazing element is increased to soften the second material, and the heat softened portion of the central portion is contacted with the first edge portion to bond therewith or thereto.

If both the first edge portion and the central portion are heated to soften the first and second materials for bonding, the heat softened portions are preferably contacted together to enable bonding by fusing.

Fusing the first edge portion of the inner glazing element with the central portion of the inner glazing element may occur when the inner glazing element is made, for example by using an extrusion process.

Thermal fusing maybe achieved by welding.

When the second edge portion is bonded to the central portion of the inner glazing element, the second edge portion may be fused with or to the central portion of the inner glazing element as just described in relation to the first edge portion of the inner glazing element being bonded to the central portion of the inner glazing element by being fused therewith or thereto.

In some embodiments the first edge portion of the inner glazing element is bonded to the central portion of the inner glazing element by being integrally formed therewith.

In such embodiments the inner glazing element is preferably formed by an extrusion process wherein the central portion and the first edge portion are formed by extruding the first material through a first die and the second material through a second die.

The first die and the second die are preferably part of a die assembly.

Preferably the first material and the second material are coextruded at the same time.

An inner glazing element formed by an extrusion process is referred to herein as an extruded inner glazing element.

A suitable extrusion process is described in U.S. Pat. No. 4,884,616.

In these embodiments, it is preferred that the first edge portion of the inner glazing element is fused to or with the central portion of the inner glazing element, more preferably wherein the first edge portion of the inner glazing element is thermally fused with or to the central portion of the inner glazing element.

When the second edge portion is bonded to the central portion of the inner glazing element, the second edge portion may be integrally formed therewith in the same way as just described when the first edge portion of the inner glazing element is integrally formed with the central portion of the inner glazing element. In particular, when the inner glazing element is extruded, the second edge portion of the inner glazing element is preferably fused with or to the central portion of the inner glazing element, more preferably wherein the second edge portion of the inner glazing element is thermally fused with or to the central portion of the inner glazing element.

Preferably the central portion is formed by extruding the first material through a first die, extruding the second material through a second die and extruding the third material through a third die.

Preferably the first material, the second material and the third material are coextruded at the same time.

In some embodiments the first material is harder than the second material and/or the third material.

The relative hardness of a material may be determined using a standard technique, for example as defined in ASTM D2240 type A and type D scales. Preferably the hardness of the first material, the second material and the third material are determined using a method as defined in ASTM D2240 type A and type D scales.

Hardness of a material may be measured using a known durometer scale.

Preferably the first material has a first Shore Hardness A and the second material has a second Shore Hardness A, wherein the first Shore Hardness A is greater than the second Shore Hardness A.

Preferably the first material has a first Shore Hardness A and the third material has a third Shore Hardness A, wherein the first Shore Hardness A is greater than the third Shore Hardness A.

Preferably the first material has a first Shore Hardness A, the second material has a second Shore Hardness A and the third material has a third Shore Hardness A, wherein the first Shore Hardness A is greater than the second Shore Hardness A and the third Shore Hardness A.

Preferably the Shore Hardness A of the second and/or third material is less than 120.

Preferably the Shore Hardness A of the first material is greater than 50.

Preferably the first material has a Shore hardness D of greater than 50.

Preferably the Shore Hardness A of the second and/or third material is greater than 10.

Preferably the first material has a Shore hardness D of less than 120.

In some embodiments the second and/or third material comprises polyvinyl chloride (PVC) ethylene vinyl acetate (EVA), polyesters, a polyolefin, an elastomer or polyurethane.

In some embodiments the second and/or third material comprises an elastomer.

In some embodiments the first material comprises a thermoplastic.

In some embodiments the first material comprises polycarbonate, polyester, or acrylic.

A suitable polyester is polyethylene terephthalate (PET).

In some embodiments the first material comprises a bunch of fibres. Suitable fibres comprise glass fibres and/or synthetic fibres and may be of the type used to provide a fibre insulation material, in particular a fibre wool material.

In some embodiments the central portion of the inner glazing element comprises a bunch of fibres. Suitable fibres comprise glass fibres and/or synthetic fibres and may be of the type used to provide a fibre insulation material, in particular a fibre wool material.

In some embodiments the central portion of the inner glazing element comprises a fibre insulation material. Suitable fibre insulation material comprises glass fibres and/or synthetic fibres.

Other embodiments have other preferable features.

Preferably the web of the first channel-section glazing element has a second flange running along a second lateral edge thereof, the second lateral edge of the web of the first channel-section glazing element being opposite the first lateral edge of the web of the first channel-section glazing element. Preferably the first and second flanges of the first channel-section glazing element both project in the same direction away from the web.

Preferably the web of the second channel-section glazing element has a second flange running along a second lateral edge thereof, the second lateral edge of the web of the second channel-section glazing element being opposite the first lateral edge of the web of the second channel-section glazing element. Preferably the first and second flanges of the second channel-section glazing element both project in the same direction away from the web.

The web of the first channel-section glazing element has a first major surface and a second opposing major surface. Preferably at least a portion of the first and/or second major surface of the web of the first channel-section glazing element has a coating thereon. Preferably the coating is a low emissivity coating. Preferably the coating is a solar control coating.

The web of the second channel-section glazing element has a first major surface and a second opposing major surface. Preferably at least a portion of the first and/or second major surface of the web of the second channel-section glazing element has a coating thereon. Preferably the coating is a low emissivity coating. Preferably the coating is a solar control coating.

In a preferred embodiment the glazing the first and second channel-section glazing elements each comprise a web, a first flange and a second flange, the first flange running along a first lateral edge of the respective web and the second flange running along a second lateral edge of the respective web, the first lateral edge of the web being opposite the second lateral edge of the web, the first and second channel-section glazing elements being arranged such that the first flange of the first channel-section glazing element faces the first flange of the second channel-section glazing element and the second flange of the first channel-section glazing element faces the second flange of the second channel-section glazing element. In this arrangement preferably the first flange of the first channel-section glazing element is coplanar with the first flange of the second channel-section glazing element and the second flange of the first channel-section glazing element is coplanar with the second flange of the second channel-section glazing element.

Preferably the inner glazing element extends between the first and second flanges of the first channel-section glazing element.

Preferably the inner glazing element extends between the first and second flanges of the second channel-section glazing element.

Preferably the first and second channel-section glazing elements are separated by a gap and the inner glazing element is positioned in the gap.

In embodiments where the first channel-section glazing element has first and second flanges, preferably the first flange of the second channel-section glazing element is received in the space between the first and second flanges of the first channel-section glazing element.

In some embodiments the web of the first and/or second channel-section glazing element is curved or corrugated, for example as in the channel-section glazing elements described in WO2008068324A1.

In some embodiments, the first channel-section glazing element is made of annealed glass and not thermally toughened glass, the second channel section glazing element is made of annealed glass and not thermally toughened glass.

In other embodiments, the first channel-section glazing element is made of annealed glass and not thermally toughened glass, the second channel section glazing element is made of annealed glass and not thermally toughened glass.

Glazings in accordance with the first aspect of the present invention have other preferable features.

Preferably the central portion of the inner glazing element is monolithic.

Preferably the first and/or second channel-section glazing element is optically transparent.

Preferably the first and/or second channel-section glazing element is laminated.

Preferably the first and/or second channel-section glazing element is coated over at least a portion thereof to provide the respective channel-section glazing element with a region having a different colour in reflected or transmitted light compared to the uncoated channel-section glazing element. Such a coating may be optically opaque. Suitably the coating is a paint.

Preferably the web of the first and/or second channel-section glazing element has a thickness between 4 mm and 12 mm, more preferably between 5 mm and 8 mm.

Preferably the or each flange of the first and/or second channel-section glazing element has a thickness of between 4 mm and 12 mm, more preferably between 5 mm and 8 mm.

Preferably the thickness of the web of the first channel-section glazing element is the same as the thickness of the or each flange of the first channel-section glazing element.

Preferably the thickness of the web of the second channel-section glazing element is the same as the thickness of the or each flange of the first channel-section glazing element.

Suitable coatings that may be useful with glazings according to the present invention include low-emissivity coatings, conductive coatings, and solar control coatings. A low emissivity coating is a coating which when applied to clear, 3 mm thick float glass, results in the coated glass having an emissivity in the range of 0.05 to 0.45, the actual value being measured in accordance with EN 12898 (a published standard of the European Association of Flat Glass Manufacturers). Suitably a low emissivity coating comprises at least one layer comprising tin oxide.

Typical solar control coatings comprise layers of silver or tin oxide and control the amount of heat absorbed through the coated glass. Solar control and low emissivity coatings may also be electrically conductive, and so not only provide functionality to the glass in terms of emissivity and heat transmission but can form an electrically conductive substrate for mounting electrically conductive devices.

Such coatings may be applied using techniques known in the art, for example atmospheric pressure chemical vapour deposition or spray pyrolysis.

When the first and/or second channel-section glazing element has two flanges, preferably the thickness of each flange is the same.

In embodiments where the inner glazing element has a central portion having a multi-wall construction, preferably at least one of the walls of the central portion has a thickness less than about 5 mm and/or a thickness greater than 0.05 mm. The thickness of at least one of the walls of the central portion may be between 0.5 mm and 3 mm.

In embodiments where the first edge portion of the inner glazing element has a first connection portion preferably having a multi-wall construction, preferably at least one of the walls of the first connection portion has a thickness less than about 5 mm and/or a thickness greater than 0.05 mm. The thickness of at least one of the first connection portion may be between 0.5 mm and 3 mm.

In embodiments where the second edge portion of the inner glazing element has a second connection portion preferably having a multi-wall construction, preferably at least one of the walls of the second connection portion has a thickness less than about 5 mm and/or a thickness greater than 0.05 mm. The thickness of at least one of the first connection portion may be between 0.5 mm and 3 mm.

In embodiments where the inner glazing element has a central portion preferably having a multi-wall construction, preferably the central portion has a thickness between 5 mm and 500 mm, or 400 mm, or 300 mm, or 200 mm, or 100 mm. The central portion may have less than 50 walls extending along a first axis, the first axis preferably being parallel to the web of the first and/or second channel-section glazing element. The central portion preferably has a plurality of walls extending along a second axis, the second axis preferably being perpendicular to the web of the first and/or second channel-section glazing element.

In embodiments where the first edge portion of the inner glazing element has a first connection portion preferably having a multi-wall construction, preferably the first connection portion has a thickness between 1 mm and 200 mm. The first connection portion preferably has a plurality of walls extending along a first axis, the second axis preferably being perpendicular to the web of the first and/or second channel-section glazing element. The first connection portion preferably has a plurality of walls extending along a second axis, the second axis preferably being perpendicular to the web of the first and/or second channel-section glazing element.

In embodiments where the second edge portion of the inner glazing element has a second connection portion preferably having a multi-wall construction, preferably the second connection portion has a thickness between 1 mm and 200 mm. The second connection portion preferably has a plurality of walls extending along a first axis, the second axis preferably being perpendicular to the web of the first and/or second channel-section glazing element. The second connection portion preferably has a plurality of walls extending along a second axis, the second axis preferably being perpendicular to the web of the first and/or second channel-section glazing element.

In embodiments where the glazing is arranged such that there is a first space between the central portion of the inner glazing element and the web of the first channel-section glazing element and a second space between the central portion of the inner glazing element and the web of the second channel-section glazing element, the webs of the first and second channel-section glazing elements are spaced apart by a spacing and the central portion has a thickness less than the spacing between the webs of the first and second channel-section glazing elements.

Preferably the central portion has a thickness that is less than 90% of the spacing between the webs of the first and second channel-section elements, more preferably less than 80%, or 70% or 60%, or 50%, or 40%, or 30%, or 20%, or 10%, or 5% of the spacing between the webs of the first and second channel-section elements.

Preferably the central portion has a thickness that is at least 2% or 3% or 4% of the spacing between the webs of the first and second channel-section elements.

Preferably the central portion has a thickness between 0.5 cm and 50 cm, more preferably between 0.5 cm and 40 cm, or 30 cm, or 20 cm, or 10 cm, or 5 cm.

Glazings in accordance with the present invention may be retrofit into existing facades comprising a plurality of channel-section glazing elements.

The present invention also provides from a second aspect an inner the inner glazing element for a glazing according to the first aspect of the present invention, the inner glazing element comprising: a central portion made of a first material, a first edge portion made of a second material and running along a first side of the central portion; and a second edge portion made of a third material and running along a second side of the central portion, the first side of the central portion being opposite the second side of the central portion; wherein the first material is different from the second material and further wherein the first edge portion of the inner glazing element is bonded to the central portion of the inner glazing element.

Preferably the second edge portion of the inner glazing element is bonded to the central portion of the inner glazing element.

Preferably the third material is the same as the second material.

Preferably the first material comprises polycarbonate, polyester, or acrylic; or a bunch of fibres.

Preferably the central portion of the inner glazing element comprises a bunch of fibres.

Preferably the second material and/or the third material comprises polyvinyl chloride (PVC) ethylene vinyl acetate (EVA), polyesters, a polyolefin, an elastomer or polyurethane.

Preferably the first edge portion of the inner glazing element is bonded to the central portion of the inner glazing element by being integrally formed therewith. In such embodiments the inner glazing element is preferably formed by an extrusion process wherein the central portion and the first edge portion are formed by extruding the first material through a first die and the second material through a second die.

Preferably the first edge portion of the inner glazing element is bonded to the central portion of the inner glazing element by an adhesive or by a mechanical fastener.

In embodiments where the second edge portion of the inner glazing element is bonded to the central portion of the inner glazing element, the second edge portion may be integrally formed therewith. In such embodiments the inner glazing element is preferably formed by an extrusion process, wherein the central portion, the first edge portion and the second edge portion are formed by extruding the first material through a first die, the second material through a second die and the third material through a third die.

Preferably the first material, the second material and the third material are coextruded at the same time.

In embodiments where the second edge portion of the inner glazing element is bonded to the central portion, preferably the second edge portion of the inner glazing element is bonded to the central portion of the inner glazing element by an adhesive or by a mechanical fastener.

From a third aspect the present invention provides a method of making an inner glazing element according to the second aspect of the present invention, the method comprising the steps: (i) providing a first liquid for the first material; (ii) providing a second liquid for the second material; (iii) forming an extrudate by coextruding the first and second liquids; wherein prior to step (iii), the first liquid is kept separate from the second liquid to prevent mixing thereof; and wherein following step (iii), the extrudate is cooled to form the inner glazing element; further wherein the cooled second liquid forming a first edge portion of the inner glazing element is bonded to the cooled first liquid forming the central portion of the inner glazing element.

Preferably the method includes before step (iii) the step of providing a third liquid for the third material; wherein during step (iii) the extrudate also includes some extruded third liquid; wherein prior to step (iii), the third liquid is kept separate from the first and second liquids to prevent mixing thereof; and wherein following step (iii), the cooled third liquid forming a second edge portion of the inner glazing element is bonded to the cooled first liquid forming the central portion of the inner glazing element.

Preferably the first liquid comprises melted polycarbonate resin.

Preferably the second liquid comprises melted polyvinyl chloride resin.

When a third liquid is used, preferably the third liquid is the same as the second liquid.

The invention will now be described with reference to the following figures (not to scale) in which,

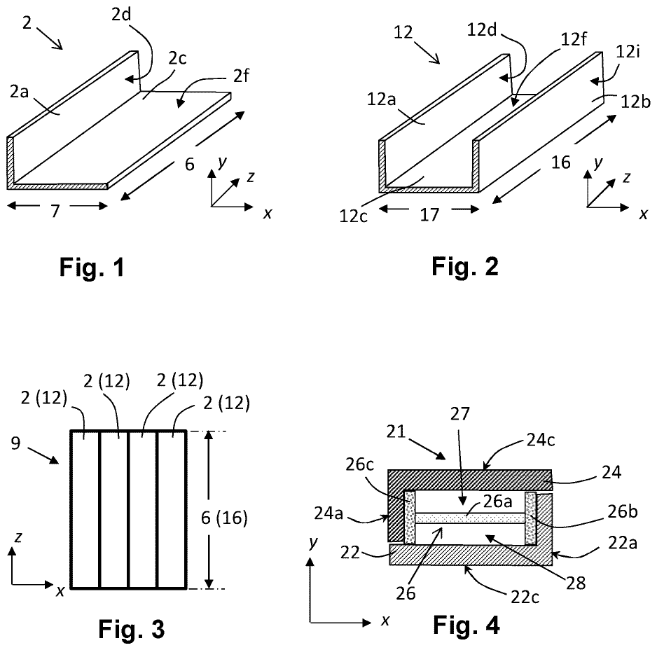

FIG. 1 is an isometric projection of a channel-section glazing element having only one flange continuous with a web;

FIG. 2 is an isometric projection of a channel-section glazing element having a web and two flanges continuous with the web;

FIG. 3 is a front view of a part of a facade for a building comprising four channel-section glazing elements;

FIG. 4 is a cross-sectional view of a glazing according to the present invention;

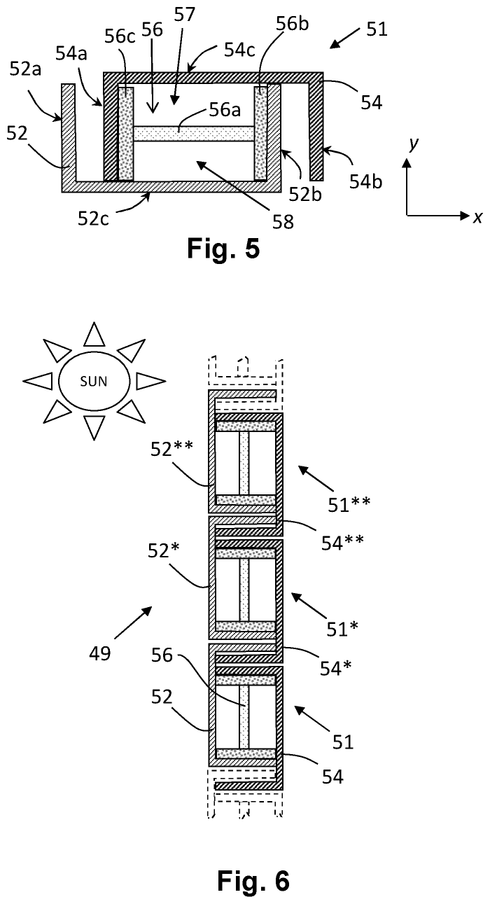

FIG. 5 is a cross-sectional view of another glazing according to the present invention;

FIG. 6 is a cross-sectional view of a facade comprising three glazings of the type shown in FIG. 5;

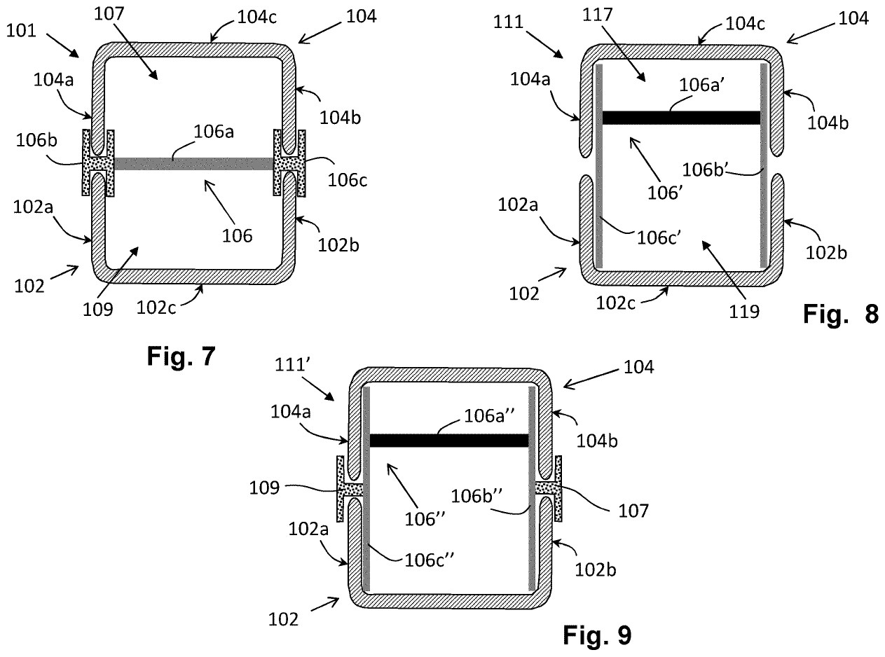

FIG. 7 is a cross-sectional view of another glazing according to the present invention;

FIG. 8 is a cross-sectional view of another glazing according to the present invention;

FIG. 9 is a cross-sectional view of another glazing according to the present invention;

FIG. 10 is a cross-sectional view of another glazing according to the present invention;

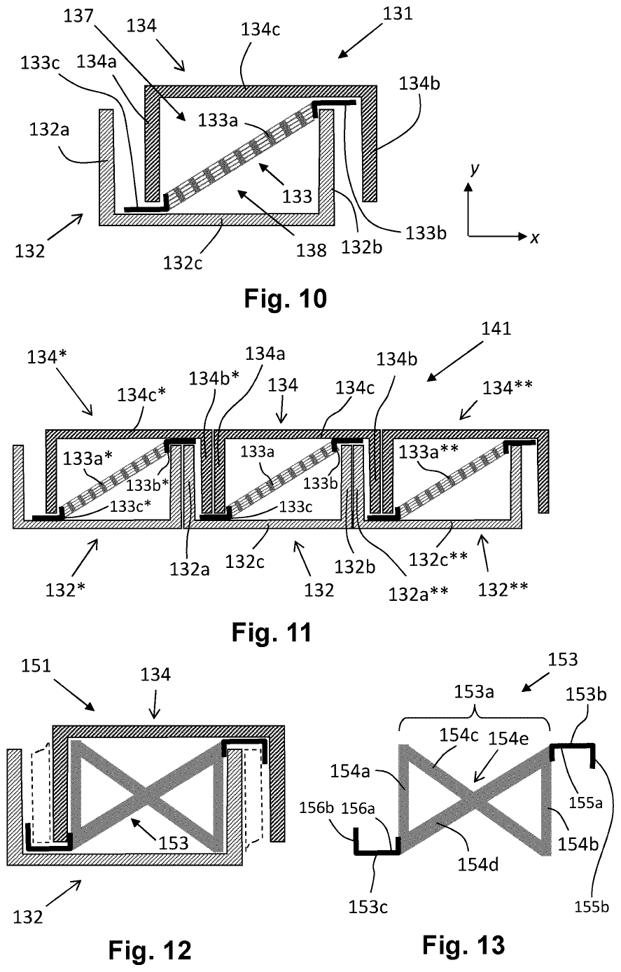

FIG. 11 is a cross-sectional view of a facade comprising three glazings of the type shown in FIG. 10;

FIG. 12 is a cross-sectional view of another glazing according to the present invention;

FIG. 13 is a cross-sectional view of the inner glazing element used in the construction of the glazing shown in in FIG. 12;

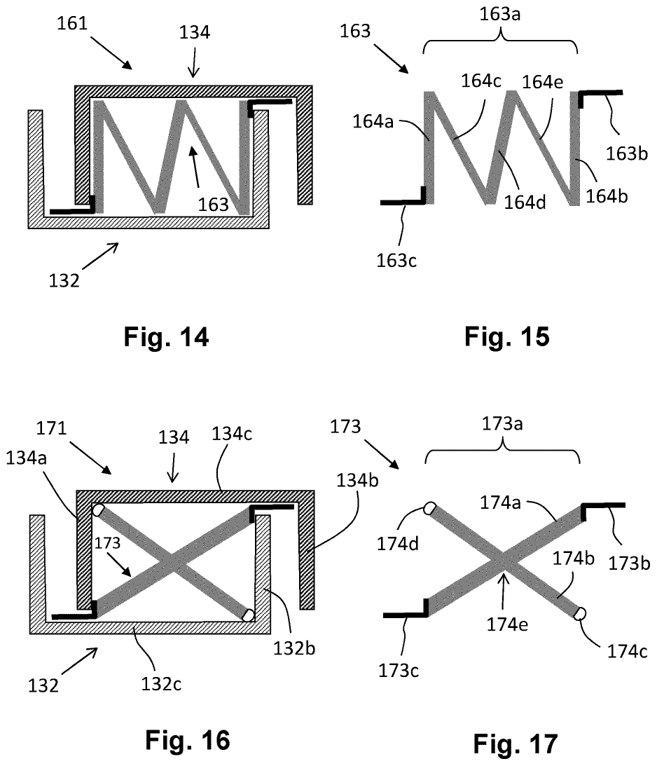

FIG. 14 is a cross-sectional view of another glazing according to the present invention;

FIG. 15 is a cross-sectional view of the inner glazing element used in the construction of the glazing shown in in FIG. 14;

FIG. 16 is a cross-sectional view of another glazing according to the present invention;

FIG. 17 is a cross-sectional view of the inner glazing element used in the construction of the glazing shown in in FIG. 16;

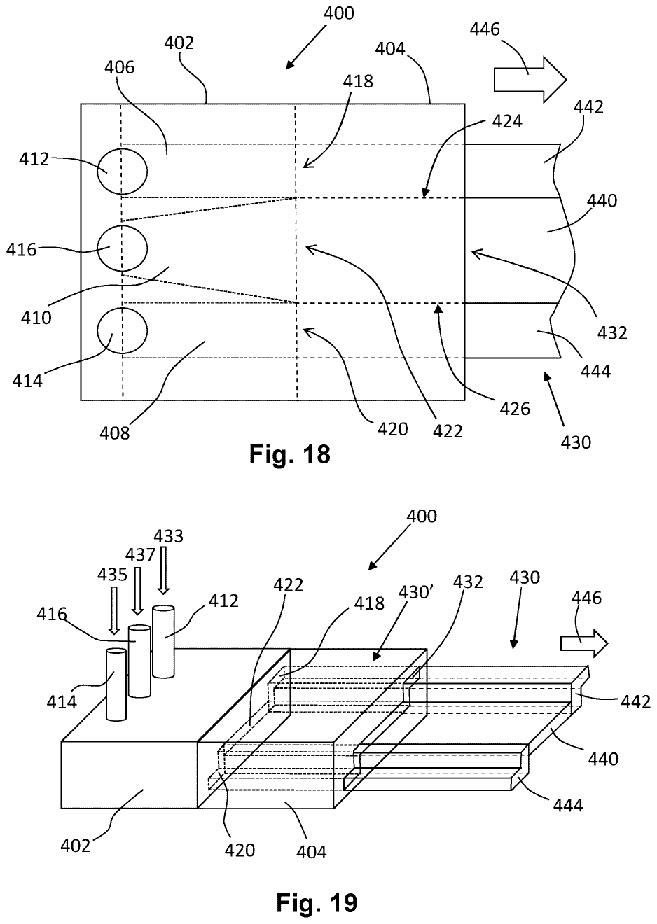

FIG. 18 is a plan view of an extrusion apparatus to make an inner glazing element for use in a glazing of the present invention; and

FIG. 19 is an isometric representation of the apparatus shown in FIG. 18.

FIG. 1 shows a schematic perspective view of one type of channel-section glazing element 2 that may be used in making a glazing in accordance with the present invention. The channel-section glazing element 2 has a flange 2a and a web 2c integrally formed therewith. The flange 2a is continuous with the web 2c and the channel-section glazing element 2 has been bent from an initially flat sheet or ribbon of glass, for example as described in DE1496047A1. The width 7 of the web may be many cm, whereas the length 6 of the web may be many tens of cm, up to several meters.

The flange 2a has a first major surface 2d and an opposing second major surface 2e (not indicated in the figure). The web 2c has a first major surface 2f and an opposing second major surface 2g (not indicated in the figure).

The flange 2a is substantially perpendicular to the web 2c. In this example the web 2c has a thickness of 7 mm and the flange 2a also has a thickness of 7 mm.

With reference to the co-ordinate system shown, the web 2c is parallel to the plane x-z. The flange 2a is parallel to the plane y-z. When viewed along the z-axis, the channel-section glazing element 2 has an “L” cross-sectional profile.

FIG. 2 shows a schematic perspective view of another type of channel-section glazing element 12 that may be used in making a glazing in accordance with the present invention.

The channel-section glazing element 12 has a first flange 12a, a second flange 12b and a web 12c. The flanges 12a, 12b are continuous (so integrally formed) with the web 12c and the channel-section glazing element 12 has been bent from an initially flat sheet or ribbon of glass, for example as described in DE1496047A1. The width 17 of the web may be many centimetres, whereas the length 16 of the web may be many tens of centimetres, up to several metres, for example 3 m to 10 m.

The first flange 12a has a first major surface 12d and an opposing second major surface 12e (not indicated in the figure). The second flange 12b has a first major surface 12h (not indicated in the figure) and an opposing second major surface 12i. The web 12c has a first major surface 2f and an opposing second major surface 12g (not indicated in the figure). The surface 12d of the first flange 12a faces the surface 12h of the second flange 12b.

The flanges 12a, 12b are each substantially perpendicular to the web 12c. In this example the web 12c has a thickness of 7 mm and the flanges 12a, 12b each have a thickness of 7 mm.

With reference to the co-ordinate system shown, the web 12c is parallel to the plane x-z. The flanges 12a, 12b are parallel to the plane y-z. When viewed along the z-axis, the channel-section glazing element 12 has a “U” cross-sectional profile.

The description of the channel-section glazing elements 2, 12 may be used in relation to the channel-section glazing elements described hereinafter.

FIG. 3 shows a front view of part of a facade 9 for a building comprising four channel-section glazing elements of the type described with reference to FIG. 1 or FIG. 2. With reference to FIG. 1 and FIG. 2, the facade is viewed in the direction of the y-axis.

As is known in the art, each channel-section glazing element 2 or 12 is arranged vertically in a supporting frame or mounting frame (not shown). For each channel-section glazing element 2 or 12 in the facade there may be suitable sealant material in between adjacent longitudinal edges.

The facade 9 may alternatively comprise horizontally orientated channel-section glazing elements.

FIG. 4 shows a cross-sectional view of a glazing 21 in accordance with the present invention. With reference to FIG. 1, this is a view in the direction of the z-axis.

The glazing 21 has a first channel-section glazing element 22 of annealed glass. The first channel-section glazing element 22 has a flange 22a and a web 22c. The flange 22a is continuous with the web 22c and the first channel-section glazing element has been bent from an initially flat sheet or ribbon of glass, for example as described in DE1496047A1.

The flange 22a is substantially perpendicular to the web 22c. The web 2c has a thickness of 7 mm. The flange 22a has a thickness of 7 mm.

The glazing 21 also has a second channel-section glazing element 24 of annealed glass. The second channel-section glazing element 24 has a flange 24a and a web 24c. The flange 24a is continuous with the web 24c and the first channel-section glazing element has been bent from an initially flat sheet or ribbon of glass, for example as described in DE1496047A1.

The flange 24a is substantially perpendicular to the web 24c. The web 24c has a thickness of 7 mm. The flange 24a has a thickness of 7 mm.

The second channel-section glazing element 24 has substantially the same dimensions as the first channel-section glazing element 22.

Both channel-section glazing elements 22, 24 are made of soda-lime-silica glass.

The first and second channel-section glazing elements are arranged such that the flange 22a of the first channel-section glazing element faces 22 faces the second channel-section glazing element 24, and the flange 24a of the second channel-section glazing element 24 faces the first channel-section glazing element 22. In this arrangement the inner facing surfaces of the channel-section glazing elements 22, 24 define a cavity.

There may be a low emissivity coating on a surface of the web 22c and/or 24c facing into the cavity.

In accordance with the present invention, the glazing 21 includes an inner glazing element 26 having a central portion 26a, a first edge portion 26b and a second edge portion 26c. The first edge portion 26b is bonded to the central portion 26a on a first side thereof, and the second edge portion 26c is bonded to the central portion on a second side thereof. The first and second sides of the central portion are on opposite sides of the central portion.

The first and second edge portions 26b, 26c are thermally fused with the central portion 26a. The central portion 26a is made from polycarbonate, which may be monolithic or multi-walled, and the first and second edge portions 26b, 26c are made from polyvinyl chloride.

The inner glazing element may be made using a suitable extrusion process.

The first edge portion 26b is in contact with and adjacent to the flange 22a. The second edge portion 26c is in contact with the and adjacent to flange 24a.

The first edge portion 26b may be attached to the flange 22a, for example by a suitable gasket over the upper ends of the flange 22a and the first edge portion 26b. Alternatively, or in addition to, the first edge portion 26b may be attached to the flange 22a using a suitable adhesive. When a layer of adhesive is used to attach the first edge portion 26b to the flange 22a, the layer of adhesive is between the flange 22a and the first edge portion 26b. Alternatively, or in addition to, the first edge portion 26b may be attached to the flange 22a by providing the first edge portion 26b with a first connection portion that preferably engages with an upper end of the flange 22a.

The second edge portion 26c may be attached to the flange 24a in a similar way as described to the way the first edge portion 26b is attached to the flange 22a, for example by a suitable gasket; and/or using a suitable adhesive; and/or by providing the second edge portion with a second connection portion that preferably engages with a lower end of the flange 24a.

In this example the inner glazing element 26 has an “H” cross-sectional profile, but the central portion 26a may be inclined at an angle to the first and second edge portions 26b, 26c such that the inner glazing element has an “N” profile which may be laterally inverted.

The inner glazing element 26 has a length the same, or substantially the same, as that of the channel-section glazing elements 22, 24. The width of the inner glazing element 26 is about the same as the distance between the inner surfaces of the flanges 22a, 24a. The width of the inner glazing element 26 may be such that the inner glazing element is a snug fit between the flanges 22a, 24a.

With respect to the orientation of the glazing 21 as shown in FIG. 4, there is an upper space 27 between the web 24c and the central portion 26a of the inner glazing element and a lower space 28 between the central portion 26a of the inner glazing element and the web 22c.

The inner glazing element 26 divides the cavity defined by the inner facing surfaces of the channel-section glazing elements 22, 24 into two airspaces. This improves noise insulation. The glazing 21 also has improved thermal insulation properties (compared to the same arrangement without the inner glazing element 26).

The central portion 26a has a thickness of about 6 mm. The first and second edge portions 26b, 26c also have a thickness of about 6 mm.

The central portion 26a may be tinted to provide a tinted glazing 21. Surfaces of the central portion 26a may be provided with coatings, such as a solar control coating, to help further improve the thermal insulation performance of the glazing 21.

FIG. 5 shows a cross-sectional view of another glazing 51 in accordance with the first aspect of the present invention. With reference to FIG. 2, this is a view in the direction of the z-axis.

The glazing 51 has a first channel-section glazing element 52 having a first flange 52a, a second flange 52b and a web 52c. The flanges 52a, 52b are continuous with the web 52c and the first channel-section glazing element has been bent from an initially flat sheet or ribbon of glass, for example as described in DE1496047A1.

The glazing 51 also has a second channel-section glazing element 54 having a first flange 54a, a second flange 54b and a web 54c. The first channel-section glazing element 52 has the same dimensions as the second channel-section glazing element 54. This is advantageous because both the first and second channel-section glazing elements can be made during the same production run.

The first and second channel-section glazing elements are arranged such that the flange 54a faces the web 52c, and the first flange 54a is between the flanges 52a, 52b. The outer surface of the flange 54a is spaced from the inner surface of the flange 52a by a sufficient amount such that a flange of another glazing may be located therebetween (as will be described with reference to FIG. 6).

As a consequence of the first and second channel-section glazing elements having the same dimensions and because the flange 52a is spaced from the flange 54a, the flange 52b is spaced from the flange 54b. The space between the outer surface of flange 52b and the inner surface of flange 54b is sufficient that a flange of an adjacent glazing may be located therebetween.

The inner surfaces of the flanges 54a, 52b and portions of the inner surfaces of the webs 52c, 54c define a cavity in which is located an inner glazing element 56. The inner glazing element 56 is between the first and second channel-section glazing elements 52, 54.

The inner glazing element 56 is similar to the inner glazing 26 described with reference to FIG. 4. The inner glazing element has a central portion 56a, a first edge portion 56b and a second edge portion 56c. The first edge portion 56b is bonded to the central portion 56a along a first side thereof. The second edge portion 56c is bonded to the central portion 56a along a second side thereof, the second side of the central portion 56a being along an opposite lateral edge of the central portion 56a to the first side of the central portion 56a.

The first and second edge portions 56b, 56c are thermally fused with the central portion 56a. The central portion 56a is made from polycarbonate and the first and second edge portions 56b, 56c are made from polyvinyl chloride (PVC).

The inner glazing element 56 may be made using a suitable extrusion process.

In an alternative embodiment, at least one of the first and second edge portions 56b, 56c is bonded to the respective edge of the central portion 56a using a suitable adhesive.

The central portion 56a of the inner glazing element 56 is located between the web 52c and web 54c. There is an upper space 57 between the web 54c and the central portion 56a of the inner glazing element 56. There is a lower space 58 between the central portion 56a of the inner glazing element 56 and the web 52c.

The inner glazing element 56 is located between the second flange 52b of the first channel-section glazing element 52 and the first flange 54a of the second channel-section glazing element 54. As a result, the second edge portion 56c of the inner glazing element 56 is adjacent the flange 54a and the first edge portion 56b of the inner glazing element is adjacent the flange 52b.

There may be a low emissivity coating or a solar control coating on the surface of the web 52c, 54c facing away from central portion 56a of the inner glazing element 56.

The low emissivity coating may comprise tin oxide.

The central portion 56a of the inner glazing element 56 has a first major surface facing web 54c and a second major surface facing web 52c. There may be a low emissivity coating or a solar control coating on either of these surfaces.

The central portion 56a and/or either of the first and second connection portions 56b, 56c may have a multi-wall construction. Such a construction helps improve thermal insulation.

The central portion 56a may be tinted such that light passing through the central portion 56a is absorbed in at least one wavelength in the region 380-780 nm, so that the transmitted light has a different colour to the incident light.

FIG. 6 shows a cross-sectional view of part of a facade 49 comprising a plurality of glazings 51. Each glazing 51 is positioned adjacent another glazing 51. To aid with the description of FIG. 6, three glazings 51, 51* and 51** are highlighted. Each glazing 51, 51* and 51* is the same as illustrated in FIG. 5, therefore each component part of glazing 51* and 51** will be referenced in the same way as for glazing 51 except with the addition of a “*” or “**” respectively after each component part. For example, glazing 51 has a first channel-section glazing element 52 having a first flange 52a. Glazing 51* therefore has a first channel-section glazing element 52* having a first flange 52a*, and so on. Likewise, glazing 51** has a first channel-section glazing element 52** having a first flange 52a**, and so on.

When installing the glazing to make facade 49, the second flange 54b* of glazing 51* fits into the space between the first flange 52a and the first flange 54a of glazing 51 such that the flange 52a faces the web 54c* of the second channel-section glazing element 54* of glazing 51*. Consequently, the flange 54b* of the second channel-section glazing element 54* of the glazing 51* faces the web 52c of the first channel-section glazing element 52 of the glazing 51.

As shown in FIG. 6, the second flange 54b** of glazing 51** fits into the space between the first flange 52a* and the first flange 54a* of glazing 51* such that the flange 52a* faces the web 54c** of the second channel-section glazing element 54** of glazing 51**. Consequently, the flange 54b** of the second channel-section glazing element 54** of the glazing 51** faces the web 52c* of the first channel-section glazing element 52* of the glazing 51*.

The glazings 51 forming the facade 49 may be vertically or horizontally orientated.

For each glazing 51 in the facade there may be suitable sealant material in between adjacent longitudinal edges.

As shown in FIG. 6, the webs 52c of each first channel-section glazing element 52 of each respective glazing 51 form the outer surface of the facade i.e. that surface facing the outside of the building in which the facade is installed. The inner facing surface is formed by the webs 54c of the second channel-section glazing element 54 of each respective glazing 51.

Due to the inclusion of an inner glazing unit in each glazing 51 (as described with reference to FIG. 5), the facade has improved thermal performance. The thermal performance can be improved further by the inclusion of a low emissivity coating on the inner glazing elements and/or the first and/or second channel-section glazing elements.

Each inner glazing element 56, 56* and/or 56** may be the same or different.

FIG. 7 shows another glazing 101 in accordance with the present invention. The glazing 101 comprises a first channel-section glazing element 102 and a second channel-section glazing element 104. Each channel section glazing element 102, 104 is of the type described with reference to FIG. 2.

The channel-section glazing element 102 has a web 102c with first and second flanges 102a, 102b at lateral edges thereof.

The channel-section glazing element 104 has a web 104c with first and second flanges 104a, 104b at lateral edges thereof.

The channel-section glazing elements 102, 104 have substantially the same dimensions.

The glazing 101 is arranged such that an end of the first flange 102a faces an end of the first flange 104a and an end of the second flange 102b faces an end of the second flange 104b.

The inner facing surfaces of the channel-section glazing elements 102, 104 define a cavity. The cavity is split into two airspaces 107, 109 by an inner glazing element 106 located in the cavity.

The inner glazing element 106 is between the channel-section glazing elements 102, 104.

The inner glazing element 106 has a central portion 106a, a first edge portion 106b and a second edge portion 106c.

In this example the central portion 106a is a multi-wall construction and is made of polycarbonate. The first edge portion 106b is bonded to the central portion 106a along a first lateral edge thereof. The second edge portion 106c is bonded to the central portion 106a along a second lateral edge thereof, the second lateral edge being opposite the first lateral edge.

The first and second edge portions 106b, 106c are both made from an elastomer, preferred elastomers being silicone rubber, ethylene propylene diene monomer (EPDM) and neoprene.

The first edge portion 106b has an “H” cross-sectional profile and is configured such that the ends of the flanges 102a, 104a engage therewith. The flanges 102a, 104a may be a snug fit with the first edge portion 106b. The flanges 102a, 104a are attached to the first edge portion 106b. Such a first edge portion 106b has first and second connection portions, the first connection portion of the first edge portion 106b engaging with the flange 102a and the second connection portion of the first edge portion 106b engaging with the flange 104a.

The second edge portion 106c is configured in the same way as the first edge portion 106b and is configured to be attached to the flanges 102b, 104b. The second edge portion 106c has first and second connection portion, the first connection portion of the second edge portion 106c engaging with the flange 102b and the second connection portion of the second edge portion 106c engaging with the flange 104b.

Given that the two channel-section glazing elements 102, 104 are substantially the same dimensions, the central portion 106a is positioned equidistant between the webs 102c, 104c. As a consequence, the two airspaces 107, 109 are the same volume. The central portion 106a may have a thickness between 5 mm and 50 mm.

The first and/or second edge portion 106b, 106c may be adhesively bonded to the central portion 106a.

The first and/or second edge portion 106b, 106c may be fused with or to the central portion 106a.

With the first and second channel-section glazing elements arranged as shown in FIG. 7, it may be desirable to position the central portion 106a at other positions in the cavity. This is shown in FIG. 8 and FIG. 9.

In an alternative embodiment to that shown in FIG. 7, the central portion is a fibre insulation material having a thickness of about 10 cm, although the thickness may be such to completely fill the cavity defined by the first and second channel-section glazing elements 102, 104; or the thickness may be less than 10 cm.

FIG. 8 shows another glazing 111 in accordance with the present invention. The glazing 111 comprises the same channel-section glazing elements 102, 104 as described with reference to the glazing 101 of FIG. 7. An inner glazing element 106′ is used to position the central portion 106a′ at a different location in the cavity. The central portion 106a′ is arranged to be positioned between the flanges 104a, 104b because the central portion is not mid-way between the first and second edge portions 106b′, 106c′. In this example, the first and second edge portions 106b′, 106c′ do not comprise a respective connection portion. The first and second edge portions 106b′, 106c′ are bonded to the central portion along opposite lateral edges thereof.

The central portion 106a′ comprises polycarbonate, either in monolithic form or multi-walled form. The first and second edge portions 106b′, 106c′ are made from polyvinyl chloride or a suitable elastomer.

FIG. 9 shows a glazing 111′ which is the same as glazing 111 except that an inner glazing element 106″ is positioned in the cavity defined by the channel-section glazing elements 102, 104. The inner glazing element 106″ has a central portion 106a″ and first and second edge portions 106b″, 106c″.

The central portion 106a″ is made of polycarbonate. The first and second edge portions 106b″ 106c″ are both made of polyvinyl chloride, although in an alternative embodiment, the first connection portion 106b″ is made from a different material compared to the second connection portion 106c″. For example, the first edge portion 106b″ may be made from EPDM or neoprene and the second edge portion 106c″ may be made from polyvinyl chloride.

The first edge portion 106b″ has integrally formed therewith a first connection portion 107. The first connection portion 107 is made of the same material as the first edge portion 106b″. The first connection portion 107 has a “T” profile in cross-section and extends away from the first edge portion 106b″ to define a first space or slot into which the end of the flange 102b can fit and a second space or slot into which the end of the flange 104b can fit. This connects the flanges 102b, 104b to the first edge portion 106b″. The end of the flange 102b may be a snug fit in the first space and the end of the flange 104b may be a snug fit in the second space.

Similarly, the second edge portion 106c″ has integrally formed therewith a second connection portion 109. The second connection portion 109 is made from the same material as the second edge portion 106c″. The second connection portion 109 has a “T” profile and extends away from the second edge portion 106c″ to define a first space or slot into which the end of the flange 102a can fit and a second space or slot into which the end of the flange 104a can fit. This connects the flanges 102a, 104a to the second edge portion 106c″. The end of the flange 102a may be a snug fit in the first space defined by one side of the second connection portion 109 and the second edge portion 106c″. The end of the flange 104b may be a snug fit in the second space defined by the other side of the second connection portion 109 and the second edge portion 106c″.

In an alternative embodiment, the first connection portion 107 is made of a different material to first edge portion 106b′″. In such an embodiment, the first connection portion 107 may be bonded to the first edge portion 106b″. Bonding may be carried out as discussed in relation to bonding the first edge portion to the central bonding.

In an alternative embodiment, the second connection portion 109 is made of a different material to second edge portion 106c′″. In such an embodiment, the second connection portion 109 may be bonded to the second edge portion 106c″.

The material of the first and second connection portions 107, 109 may be the same or different.

FIG. 10 shows a cross-sectional view of another glazing 131 in accordance with the present invention. With reference to FIG. 2, this is a view in the direction of the z-axis. The glazing 131 is similar to the glazing 51 of FIG. 5.

The glazing 131 has a first channel-section glazing element 132 having a first flange 132a, a second flange 132b and a web 132c. The flanges 132a, 132b are continuous with the web 132c and the first channel-section glazing element has been bent from an initially flat sheet or ribbon of glass, for example as described in DE1496047A1.

The glazing 131 also has a second channel-section glazing element 134 having a first flange 134a, a second flange 134b and a web 134c. The first channel-section glazing element 132 has the same dimensions as the second channel-section glazing element 134. This is advantageous because both the first and second channel-section glazing elements can be made during the same production run.

The first channel-section glazing element 132 and second channel-section glazing element 134 are each of the type as described in relation to FIG. 2.

The first and second channel-section glazing elements 132, 134 are arranged such that the first flange 134a faces the web 132c, and the first flange 134a is received in the space between the flanges 132a, 132b. The flanges 132a, 134a are sufficiently spaced apart such that a flange of another glazing may be located therebetween.

As a consequence of the first and second channel-section glazing elements 132, 134 having the same dimensions and because the flange 132a is spaced from the flange 134a, the flange 132b is spaced from the flange 134b. The flange 132b is sufficiently spaced apart from the flange 134b such that a flange of an adjacent glazing may be located therebetween.

The inner surfaces of the flanges 134a, 132b and portions of the inner surfaces of the webs 132c, 134c define a cavity in which is located an inner glazing element 133. The inner glazing element 133 is between the first and second channel-section glazing elements 132, 134.

The inner glazing element 133 has a central portion 133a made of polycarbonate and having a multi-walled construction. Along a first lateral edge of the central portion 133a there is a first edge portion 133b is bonded thereto. Along a second lateral edge of the central portion 133a there is a second edge portion 133c is bonded thereto. The first lateral edge or side of the central portion 133a is opposite the second lateral edge or side of the central portion. The first and second edge portions 133b, 133c are each made of polyvinyl chloride, or an elastomer.

Each of the first and second edge portions 133b, 133c have an “L” shaped cross-sectional profile. A portion of the first edge portion 133b is positioned between the end of the flange 132b and the web 134c. By having the first edge portion made of polyvinyl chloride and by being bonded to the central portion 133a of the inner glazing element 133, it is no longer necessary to have a separate gasket over the end of the flange 132b. This simplifies assembly and reduces costs as one less component part is required.

Similarly, a portion of the second edge portion 133c is positioned between the end of the flange 134a and the web 132c. By having the second edge portion made of polyvinyl chloride and by being bonded to the central portion 133a of the inner glazing element 133, it is no longer necessary to have a separate gasket over the end of the flange 134a.

Furthermore, since the first and second edge portions 133b, 133c are bonded to the central portion 133a, the positions thereof are suitably maintained by the support provided by the central portion 133a.

The multi-walled central portion 133a helps improve the thermal insulation performance of the glazing 131.

There is an upper space 137 between the web 134c and the central portion 133a. There is a lower space 138 between the central portion 133a and the web 132c.

There may be a low emissivity coating or a solar control coating on the surface of the web 132c, 134c facing the central portion 133a.

There may be a low emissivity coating or a solar control coating on the surface of the web 132c, 134c facing away from the central portion 133a.

The low emissivity coating may comprise tin oxide.

There may be a solar control coating on the web 132c and/or web 134c. There may be a solar control coating on the web 132c and/or web 134c. There may be a solar control coating on the web 132c and a solar control coating on the web 134c.

In this example the central portion 133a has a multi-wall configuration comprising a plurality of walls extending horizontally and vertically to define a plurality of air-spaces. Other arrangement of walls is also possible, for example as a honeycomb.

There may be a coating on the outer walls of the central portion 133a, for example a low emissivity coating and/or a solar control coating and/or a coating to provide the central portion with a colour.

The first and second edge portions 133b, 133c have a single wall construction.

FIG. 11 shows a cross-sectional view of a facade 141 comprising a plurality of glazings 131 of the type shown in FIG. 10. Each glazing 131 is positioned adjacent another glazing 131.

To aid with the description of FIG. 10, three glazings 131, 131* and 131** are highlighted. Each glazing 131, 131* and 131** is the same as illustrated in FIG. 10, therefore each component part of glazing 131* and 131** will be referenced in the same way as for glazing 131 except with the addition of a “*” or “**” respectively after each component part.

When installing the glazing to make facade 141, the second flange 134b* of glazing 131* fits into the space between the flange 132a and the flange 134a of glazing 131 such that the flange 132a faces the web 134c* of the second channel-section glazing element 134* of glazing 131*. Consequently, the flange 134b* of the second channel-section glazing element 134* of the glazing 131* faces the web 132c of the first channel-section glazing element 132 of the glazing 131.

The glazings 131 forming the facade 141 may be vertically or horizontally orientated.

For each glazing 131, 131*, 131** etc. in the facade there may be suitable sealant material in between adjacent longitudinal edges.

With reference to FIGS. 10 and 11, in the space between the first flange 134a of the channel-section glazing element 134 and the first flange 132a of the channel-section glazing element 132 is the second flange 134b* of the channel-section glazing element 134*.

The second edge portion 133c of the inner glazing element 133 is positioned between the ends of the first flange 134a and the second flange 134b* and the web 132c.

The first edge portion 133b is configured in the same way and is shown between the ends of the flanges 132b, 132a** and the web 134.

Since the first and second edge portions 133b, 133c are made of PVC, it is not necessary to have a gasket or the like over the ends of the flanges 134a, 134b* and 132a**, 132b. The relatively soft first and second edge portions 133b, 133c provide a means of cushioning the ends of the flanges against the respective web during vibrations, such as due to wind against the front of the façade 141. The first and second edge portions 133b, 133c also position the central portion 133a in the correct position in the cavity formed by the two channel-section glazing elements 132, 134.

In an alternative to the embodiment shown with reference to FIGS. 10 and 11, the first and second edge portion 133b, 133c each have a respective end portion for providing a respective connection portion.

In this alternative embodiment, a first connection portion extends part way down the flange 132a** towards the web 132c** and is positioned between the flange 132a** and the flange 134b.

A second connection portion between the flanges 132a, 134b* extends part way up the flange 134b* towards the web 134c*.

The first connection portion helps attach the first edge portion 133b to the flanges 132b, 132a** and the second connection portion helps attach the second edge portion 133c to the flanges 134a, 134b*.

The first connection portion may be integrally formed with the first edge portion 133b. The second connection portion may be integrally formed with the second edge portion 133c.

FIG. 12 shows a cross-sectional view of another glazing 151 that is similar to the glazing 131 shown in FIG. 10 except a different inner glazing element 153 is used therewith. The inner glazing element 153 is shown separately in FIG. 13.

With reference to FIGS. 12 and 13, the inner glazing element 153 comprises a central portion 153a, a first edge portion 153b and a second edge portion 153c. The first and second edge portions 153b, 153c are bonded to the central portion 153a by being integrally formed therewith.

The central portion 153a is made from polycarbonate and the first and second edge portions 153b, 153c are made from polyvinyl chloride.

The central portion 153a includes a first vertical member 154a, a second vertical member 154b, a first inclined member 154c and a second inclined member 154d. Each of the members 154a, 154b, 154c and 154d are substantially sheet-like, although they may have a multi-wall configuration.

The first and second inclined members 154c, 154d intersect at region 154e forming an ‘X’ in cross-sectional profile.

The first vertical member 154a is bonded at a lower end to the second edge portion 153c and joined at the opposite upper end thereof to the upper end of the first inclined member 154c.

The second vertical member 154b is bonded at an upper end to the first edge portion 153b and joined at the opposite lower end thereof to the lower end of the first inclined member 154c.

The second inclined member 154d is joined at a lower end thereof to the lower end of the first vertical member 154a and at an upper end thereof to the upper end of the second vertical member 154b.

The central portion 153a may be unitary having been formed by an extrusion process.

The first edge portion 153b has an ‘L’-shaped portion (‘L’-shape in cross-section) 155a extending away from the upper end of the second vertical member 154b. At one end, the ‘L’-shaped portion 155a is bonded to the upper end of the second vertical member 154b. At a second end, the ‘L’-shaped portion 155a has a first connection portion 155b extending downwards, being substantially parallel to the second vertical member 154b. The first connection portion 155b is integrally formed with the ‘L’-shaped portion 155a.

The second edge portion 153c has an ‘L’-shaped portion (again, (‘L’-shape in cross-section) 156a extending away from the lower end of the first vertical member 154a. At one end, the ‘L’-shaped portion 156a is bonded to the lower end of the first vertical member 154a. At a second end, the ‘L’-shaped portion 156a has a first connection portion 156b extending upwards, being substantially parallel to the first vertical member 154a. The first connection portion 156b is integrally formed with the ‘L’-shaped portion 156a.

As shown in FIG. 12, the glazing 151 is arranged such that the first edge portion 153b is between the upper ends of two flanges of adjacent channel-section glazing elements (one being the channel-section glazing element 132) and the web of the channel-section glazing element 134; and the second edge portion 153c is between the lower ends of two flanges of adjacent channel-section glazing elements (one being channel-section glazing element 134) and the web of the channel-section glazing element 132. The first connection portions 155b, 156b of the respective first and second edge portions help connect the inner glazing element 153 to the ends of the flanges as shown in FIG. 12.

FIG. 14 shows a cross-sectional view of another glazing 161 that is similar to the glazing 131 shown in FIG. 10 except a different inner glazing element 163 is used therewith. The inner glazing element 163 is shown separately in FIG. 15.

With reference to FIGS. 14 and 15, the inner glazing element 163 comprises a central portion 163a, a first edge portion 163b and a second edge portion 163c. The first and second edge portions 163b, 163c are bonded to the central portion 163a by being integrally formed therewith, having been formed by an extrusion process.

The central portion 163a is made from polycarbonate and the first and second edge portions 163b, 163c are made from polyvinyl chloride.

The central portion 163a includes a first vertical member 164a and a second vertical member 164b. Between the first and second vertical members 164a, 164b are a plurality of inclined members (in this example three) arranged in a saw tooth manner. That is, the upper end of the inclined member 164c is joined to the upper end of the first vertical member 164a and the lower end of the inclined member 164c is joined to the lower end of the inclined member 164d. The upper end of the inclined member 164d is joined to the upper end of the inclined member 164e. The lower end of the inclined member 164e is joined to the lower end of the second vertical member 164b.

The lower end of the first vertical member 164a is bonded to the second edge portion 163c.

The upper end of the second vertical member 164b is bonded to the first edge portion 163b.

The first and second edge portions 163b, 163c are substantially ‘L’-shaped in cross-section.

Each of the members 164a, 164b, 164c, 164d and 164e are substantially sheet-like, although they may have a multi-wall configuration.

In an alternative embodiment to that shown in FIGS. 14 and 15, the first and second edge portions are bonded 163b, 163c to the central portion 163a by an adhesive. In such an embodiment, the central portion 163a may be formed by an extrusion process. The first and/or second edge portions 163b, 163c may also be formed by an extrusion process.

FIG. 16 shows a cross-sectional view of another glazing 171 that is similar to the glazing 131 shown in FIG. 10 except a different inner glazing element 173 is used therewith. The inner glazing element 173 is shown separately in FIG. 17.

With reference to FIGS. 16 and 17, the inner glazing element 173 comprises a central portion 173a, a first edge portion 173b and a second edge portion 173c. The first and second edge portions 173b, 173c are bonded to the central portion 173a by being integrally formed therewith, having been formed by an extrusion process.

The central portion 173a is made from polycarbonate or other suitable plastic and the first and second edge portions 173b, 173c are made from PVC or an elastomer.

The central portion 173a includes a first inclined member 174a and a second included member 174b. The first and second inclined member 174a 174b have an intersection at 174e forming an element having an ‘X’-shaped cross-sectional profile.

The first edge portion 173b is bonded to an upper end of the first inclined member 174a.

The second edge portion 173c is bonded to a lower end of the first inclined member 174a.

The first and second edge portions 173b, 173c are substantially ‘L’-shaped in cross-section.

Each of the first and second inclined members 174a, 174b are substantially sheet-like, although they may have a multi-wall configuration.

The second inclined member 174b has a lower end and an upper end. The lower end is configured to rest against the intersection between the web 132c and the flange 132b of the channel-section glazing element 132. The upper end is configured to rest against the intersection between the web 134c and the flange 134a of the channel-section glazing element 134.

At the lower end of the second inclined member 174b is a first hollow portion 174c configured to absorb and/or cushion any vibrations imparted to the glazing 171 between the inner glazing element 173 and the channel-section glazing element 132.

At the upper end of the second inclined member 174b is a second hollow portion 174d also configured to absorb and/or cushion any vibrations imparted to the glazing 171 between the inner glazing element 173 and the channel-section glazing element 134.

In an alternative embodiment, the second inclined member 174b has only one hollow portion at one end thereof.

In another alternative embodiment, the second inclined member 174b has no hollow portions at either end thereof.

In an alternative embodiment to that shown in FIGS. 16 and 17, the first and second edge portions 173b, 173c are bonded to the central portion 173a by an adhesive and not integrally formed therewith.

In the previous examples, the central portion may be optically transparent or translucent. The central portion of the inner glazing element may be tinted to provide a transmitted colour when viewed therethrough. At least a portion of the central portion may be coated, for example with a low emissivity coating or a solar control coating. The coating may be used to provide the central portion with a colour, for example the coating may be an optically opaque paint or allow light to be transmitted therethrough.

FIG. 18 shows a schematic plan view of an extrusion apparatus 400 used to make an inner glazing element for use in a glazing according to the first aspect of the present invention. FIG. 19 shows a schematic isometric representation of the extrusion apparatus 400.

With reference to FIGS. 18 and 19, the extrusion apparatus 400 includes a first chamber 402 and a second chamber 404 downstream thereof. The first chamber 402 is divided into three inner chambers 406, 408 and 410. Each of the inner chambers 406, 408, 410 has a respective inlet 412, 414, 416 for supplying a suitable liquid material to the respective inner chamber. Liquid that flows into each inner chamber can flow out of a respective outlet to pass into the second chamber 404. The second chamber 404 conditions the material that is extruded through the outlets in the inner chambers 406, 408, 410. The cooled and solidified inner glazing element then emerges from the outlet in the exit end of the second chamber 404.

Each inner chamber may have a suitably configured pump or hydraulic system to force the liquid in the respective inner chamber through the outlet in the respective inner chamber.

The first inner chamber 406 has an inlet 412 and an outlet 418.

The second inner chamber 408 has an inlet 414 and an outlet 420.

The third inner chamber 410 has an inlet 416 and an outlet 422.

In this example, the outlet 418 of the first inner chamber 406 is configured as an “L” shape. The outlet 420 of the second inner chamber 408 is also configured as an “L” shape but rotated about 180° compared to the outlet 418. The two outlets 418, 420 are joined by a rectangular outlet 422 in the third inner chamber 410.

In the first chamber 402 the three inner chambers 406, 408, 410 are configured not to permit mixing of any liquid inside the inner chambers 406, 408, 410. Mixing is possible at the interface between adjacent outlets. For example, upon a first liquid exiting the outlet 418 and a second liquid exiting the outlet 422, mixing is possible at the interface between the outlets 418 and 422. The interface between the outlets 418 and 422 is illustrated in FIG. 18 by the dotted line 424.

Similarly, upon a third liquid exiting the outlet 420 and a second liquid exiting the outlet 422, mixing is possible at the interface between the outlets 420 and 422. The interface between the outlets 420 and 422 is illustrated in FIG. 18 by the dotted line 426.

When the respective liquid in the respective inner chamber exits from the respective outlet, the viscosity thereof is sufficient for extrusion. Suitable heating means, such as electric strip heaters may be provided in each inner chamber to allow the appropriate temperature of the liquid inside to be achieved.

The extruded inner glazing element 430 passes through the second chamber 404 and leaves the outlet 432 therein having become sufficiently cool and dimensionally stable.

Due to the arrangement of the outlets 418, 420 and 422, as the liquid in each respective inner chamber passes through the respective outlet, slight mixing may occur at the interface regions 424, 426 such that the liquid extruded from the outlet 418, once cooled, is fused to the liquid extruded from the outlet 422, once cooled. Likewise, liquid extruded from the outlet 420, once cooled, is fused to the liquid extruded from the outlet 422, once cooled.

The resulting extruded inner glazing element has a central portion 440, a first edge portion 442 and a second edge portion 444. The first edge portion 442 is bonded to the central portion 440 along a first side thereof due to the fusion of the liquids used to make the first edge portion and the central portion that occurs after the liquids flow from the respective outlets 418, 422. The second edge portion 444 is bonded to the central portion 440 along a second side thereof, the second side being opposite the first side, due to the fusion of the liquids used to make the second edge portion and the central portion that occurs after the liquids flow from the respective outlets 420, 422.

By altering the shape of the outlets 418, 420 and 422 a different inner glazing element with a different cross-sectional profile may be made.

A suitable liquid for use in the extrusion apparatus 400 includes melted polyvinyl chloride resin and melted polycarbonate resin.

The inner glazing element 430 is made according to the following process.

Melted polyvinyl chloride resin 433 is provided to the first inner chamber 406 via the inlet 412. Melted polyvinyl chloride resin 435 is provided to the second inner chamber 408 via the inlet 414. Melted polycarbonate resin 437 is provided to the third inner chamber 410 via the inlet 416.

The melted resins pass through the respective chamber to be discharged therefrom via the respective outlet 418, 420, 422. On one side, the melted polyvinyl chloride resin 433 discharged from the outlet 418 in the first inner chamber 406 fuses with the melted polycarbonate resin 437 discharged from the outlet 422 in the third inner chamber. On the opposite side, the melted polyvinyl chloride resin 435 discharged from the outlet 420 in the second inner chamber 408 fuses with the melted polycarbonate resin 437 discharged from the outlet 422 in the third inner chamber.

The hot extrudate 430′ in the second chamber 404 may not be able to hold its own shape so may be supported on suitable guide formers (not shown) positioned in the second chamber 404. As the hot extrudate in the second chamber 404 is cooled, for example using cooling air from fans, the cooled extrudate becomes sufficiently rigid so is able to be carried on a suitable conveyor system, which may include a plurality of conveyor rollers, to convey the inner glazing element 430 away from the extrusion apparatus in the direction of arrow 446.

The inner glazing element 430 may be cut to the appropriate length for use in making a glazing in accordance with the present invention.

By using an extrusion process to make the inner glazing element 430 the first and second edge portions 442, 444 are integrally formed with the central portion 440.

A similar extrusion apparatus and process is described in U.S. Pat. No. 4,884,616.

Suitable tinting agents may be added to the liquids used to form the extruded inner glazing element. Once extruded, the central portion 440 may be provided with a coating on one or both major surfaces thereof, for example, a solar control coating, a paint, or a coating to provide the central portion with a tinted colour in transmission.

Such coating may be provided before or after the inner glazing element has been cut into suitable length for inclusion in a glazing according to the present invention.

The present invention provides a glazing that incorporates an inner glazing element between first and second channel-section glazing elements to improve thermal performance. By using an inner glazing element wherein at least one edge portion thereof is bonded to a central portion of the inner glazing element helps reduce construction time. Also, there is no need for separate components so that inventory costs and storage requirements can also be reduced. The material of the central portion may be chosen to provide the glazing with improved thermal performance, whereas the first edge portion may be chosen to provide desirable characteristics for this part of the inner glazing element, in particular to help with connection to one or more flanges of channel-section glazing elements used to form the glazing.

Accordingly, glazings comprising first and second channel-section glazing elements are described. The first and second channel-section glazing elements are arranged to define a cavity in which an inner glazing element is located. The inner glazing element comprises a central portion made of a first material, a first edge portion made of a second material and running along a first side of the central portion and a second edge portion made of a third material running along a second side of the central portion. The first material is different from the second material and the first edge portion is bonded to the central portion of the inner glazing element and is preferably integrally formed therewith. In preferred embodiments the second edge portion is also bonded to the central portion and preferably integrally formed therewith. Methods of making the inner glazing element are also described.

1.-28. (canceled)

29. A glazing comprising:
a first channel-section glazing element and a second channel-section glazing element, the first and second channel-section glazing elements each comprising a web and a first flange, the first flange running along a first lateral edge of the respective web,
the first and second channel-section glazing elements being arranged such that an end of the first flange of the first channel-section glazing element faces the second channel-section glazing element and an end of the first flange of the second channel-section glazing element faces the first channel-section glazing element,
wherein at least a portion of an inner glazing element is located between the web of the first channel-section glazing element and the web of the second channel-section glazing element,
the inner glazing element comprising:
a central portion made of a first material,
a first edge portion made of a second material and running along a first side of the central portion; and
a second edge portion made of a third material and running along a second side of the central portion,
the first side of the central portion being opposite the second side of the central portion;
wherein the first material is different from the second material and
further wherein the first edge portion of the inner glazing element is bonded to the central portion of the inner glazing element.

30. The glazing according to claim 29, wherein the second edge portion of the inner glazing element is bonded to the central portion of the inner glazing element.

31. The glazing according to claim 30, wherein the second edge portion of the inner glazing element is bonded to the central portion of the inner glazing element by being integrally formed therewith; or wherein the second edge portion of the inner glazing element is bonded to the central portion of the inner glazing element by an adhesive, optionally a permanent adhesive or a re-stickable adhesive; or by a mechanical fastener, optionally a hook and loop fastener.

32. The glazing according to claim 29, wherein the third material is the same as the second material.

33. The glazing according to claim 29, wherein the central portion of the inner glazing element fills the space between the web of the first channel-section glazing element and the web of the second channel-section glazing element; or wherein the central portion of the inner glazing element is configured such that there is a first space between the central portion of the inner glazing element and the web of the first channel-section glazing element and/or a second space between the central portion of the inner glazing element and the web of the second channel-section glazing element.

34. The glazing according to claim 29, wherein the central portion of the inner glazing element has a multi-wall construction comprising a first wall facing the web of the first channel-section glazing element and a second wall facing the web of the second channel-section glazing element, there being a plurality of air-spaces between the first and second walls of the central portion of the inner glazing element; and/or wherein the central portion of the inner glazing element comprises a fibre insulation material.

35. The glazing according to claim 29, wherein the web of the first channel-section glazing element has a second flange running along a second lateral edge thereof, the second lateral edge of the web of the first channel-section glazing element being opposite the first lateral edge of the web of the first channel-section glazing element, optionally wherein the first channel-section glazing element has a U-shaped profile.

36. The glazing according to claim 29, wherein the web of the second channel-section glazing element has a second flange running along a second lateral edge thereof, the second lateral edge of the web of the second channel-section glazing element being opposite the first lateral edge of the web of the second channel-section glazing element, optionally wherein the second channel-section glazing element has a U-shaped profile.

37. The glazing according to claim 29, wherein the first flange of the first and second channel-section glazing elements each has a respective first end opposite the respective web thereof, the glazing being arranged such that the first end of the first flange of the first channel-section glazing element faces the first end of the first flange of the second channel-section glazing element, and the web of the first channel-section glazing element has a second flange running along a second lateral edge thereof, the second lateral edge of the web of the first channel-section glazing element being opposite the first lateral edge of the web of the first channel-section glazing element; and the web of the second channel-section glazing element has a second flange running along a second lateral edge thereof, the second lateral edge of the web of the second channel-section glazing element being opposite the first lateral edge of the web of the second channel-section glazing element; an end of the first flange of the first channel-section glazing element faces an end of the first flange of the second channel-section glazing element and an end of the second flange of the first channel-section glazing element faces an end of the second flange of the second channel-section glazing element.

38. The glazing according to claim 29, wherein the first edge portion of the inner glazing element is bonded to the central portion of the inner glazing element by being integrally formed therewith.

39. The glazing according to claim 29, wherein the first edge portion of the inner glazing element is bonded to the central portion of the inner glazing element by being fused therewith or thereto, optionally wherein the first edge portion of the inner glazing element is thermally fused with or to the central portion of the inner glazing element.

40. The glazing according to claim 29, wherein the first edge portion of the inner glazing element is bonded to the central portion of the inner glazing element by an adhesive, optionally a permanent adhesive or a re-stickable adhesive; or by a mechanical fastener, optionally a hook and loop fastener.

41. The glazing according to claim 29, wherein the first material is harder than the second material and/or the third material.

42. The glazing according to claim 29, wherein the first material comprises a thermoplastic, polycarbonate, polyester, or acrylic; or wherein the first material comprises a bunch of fibres.

43. The glazing according to claim 29, wherein the second material and/or the third material comprises polyvinyl chloride (PVC) ethylene vinyl acetate (EVA), polyesters, a polyolefin, an elastomer or polyurethane.

44. An inner glazing element for a glazing according to claim 29, the inner glazing element comprising:
a central portion made of a first material,
a first edge portion made of a second material and running along a first side of the central portion; and
a second edge portion made of a third material and running along a second side of the central portion, the first side of the central portion being opposite the second side of the central portion;
wherein the first material is different from the second material and
further wherein the first edge portion of the inner glazing element is bonded to the central portion of the inner glazing element.

45. The inner glazing element according to claim 44, wherein the second edge portion of the inner glazing element is bonded to the central portion of the inner glazing element.

46. The inner glazing element according to claim 45, wherein at least one of the first edge portion of the inner glazing element and the second edge portion of the inner glazing element is bonded to the central portion of the inner glazing element by being integrally formed therewith or wherein the at least one of the first edge portion of the inner glazing element and the second edge portion of the inner glazing element is bonded to the central portion of the inner glazing element by an adhesive or by a mechanical fastener.

47. A method of making an inner glazing element according to claim 44, the method comprising the steps:
(i) providing a first liquid for the first material;
(ii) providing a second liquid for the second material;
(iii) forming an extrudate by coextruding the first and second liquids;
wherein prior to step (iii), the first liquid is kept separate from the second liquid to prevent mixing thereof;
and wherein following step (iii), the extrudate is cooled to form the inner glazing element;
further wherein the cooled second liquid forming a first edge portion of the inner glazing element is bonded to the cooled first liquid forming the central portion of the inner glazing element.

48. The method according to claim 47, including before step (iii) the step of providing a third liquid for the third material; wherein during step (iii) the extrudate also includes some extruded third liquid;
wherein prior to step (iii), the third liquid is kept separate from the first and second liquids to prevent mixing thereof;
and wherein following step (iii), the cooled third liquid forming a second edge portion of the inner glazing element is bonded to the cooled first liquid forming the central portion of the inner glazing element.
